(19) United States
(12) Patent Application Publication
(10) Pub. No.: US 2022/0391929 A1
(43) Pub. Date: Dec. 8, 2022

(54) SYSTEMS AND METHODS TO PROVIDE A QUESTION SERIES

(71) Applicant: HODI, INC., New York, NY (US)

(72) Inventors: Matthew Bahr, New York, NY (US); Curt Hasselschwert, Coldwater, MI (US)

(21) Appl. No.: 17/338,956

(22) Filed: Jun. 4, 2021

(51) Int. Cl. G06Q 30/02; G06Q 30/06

(52) U.S. Cl. CPC G06Q 30/0203; G06Q 30/0222; G06Q 30/0635

(57) ABSTRACT

Systems and methods to provide a question series are disclosed. Exemplary implementations may: receive and store in electronic storage questions, parameters, criteria to the parameters, and events from a user; generate, based on the parameters and the questions, a question series for presentation to individual ones of the consumers; effectuate presentation of a set of the questions of the question series via individual client computing platforms associated with the consumers; obtain responses to the set of the questions from the consumers; obtain indications of the occurrence of the events related to the individual consumers; adjust the ensuing questions for presentation of the question series based on the occurrence of the events and/or the responses; and effectuate presentation of a subsequent set of the questions of the question series via individual client computing platforms of the consumers based on the adjustment to the ensuing questions.

### FIELD OF THE DISCLOSURE

The present disclosure relates to systems and methods to provide a question series.

### BACKGROUND

Businesses, particularly businesses with an online platform, may obtain feedback from their consumers and information about their consumers via surveys. However, surveys may often be too long, too general, and not customized or adjusted to the individual consumers. Additionally, consumers may not be presented questions that are based on their utilization of the online platform and their responses throughout their continuous interaction with the online platform.

### SUMMARY

One aspect of the present disclosure relates to a system configured to provide a customized question series for individual consumers of an online platform for a business. A user associated with the business may specify what questions to present to the consumers, parameters that correspond to the questions, criterion for the parameters, events that correspond to particular questions or cause presentation of the questions, and/or other information. Based on such, question series may be generated for the consumers. The questions comprising the question series may be presented to the consumer based on the events. Based on the events and/or responses to the questions from the consumers, the ensuing (or upcoming) questions of the individual question series for the consumers may be adjusted. As such, the questions presented to the consumers may be customized based on their individual interactions with the online platform. The customized question series may facilitate obtaining accurate information about the individual consumers which may be utilized by the business. The business may utilize the information about the individual consumers to modify merchandise or services they offer, present particular content to the individual consumers, design different merchandise or user interfaces, among others.

One aspect of the present disclosure relates to a system configured to provide a question series. The system may include one or more hardware processors configured by machine-readable instructions. Machine-readable instructions may include one or more instruction components. The instruction components may include computer program components. The instruction components may include one or more of question series generation component, presentation component, information obtaining component, question adjusting component, and/or other instruction components.

The question series generation component may be configured to receive questions for consumers, parameters, criteria to the parameters, and events from a client may computing platform associated with a user. Occurrence of the events, satisfaction of the criteria, and particular values to the individual parameters may affect presentation of particular ones of the questions. Some of the questions may correspond to individual ones of the parameters. The event may correspond to particular ones of the questions.

The question series generation component may be configured to store, in electronic storage, the questions, the parameters, the criteria to some of the parameters, the events, and/or other information to electronic storage.

The question series generation component may be configured to generate a question series for presentation to individual ones of the consumers. The question series may be generated based on the parameters, the questions, and/or other information. The questions of the question series may be adjusted responsive to the occurrence of the events in relation to the individual consumers presented with the questions, responsive to the satisfaction of the criterion, based on values to the parameters, and/or based on other information.

The presentation component may be configured to effectuate presentation of a set of the questions of the question series via individual client computing platforms associated with the consumers.

The information obtaining component may be configured to obtain responses to the set of the questions from the individual client computing platforms associated with the consumers. The responses may include the values to the parameters.

The information obtaining component may be configured to obtain, in an ongoing manner, indications of the occurrence of the events related to the individual consumers that occurred.

The question adjusting component may be configured to adjust the ensuing questions for presentation of the question series based on the occurrence of the events, the responses, and/or other information.

The presentation component may be configured to effectuate presentation of a subsequent set of the questions from the question series via individual client computing platforms of the consumers based on the adjustment to the ensuing questions.

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to provide a question series, in accordance with one or more implementations.

FIG. 2 illustrates a method to provide a question series, in accordance with one or more implementations.

FIG. 3-D illustrate an example implementation of the system configured to provide a question series, in accordance with one or more implementations.

### DETAILED DESCRIPTION

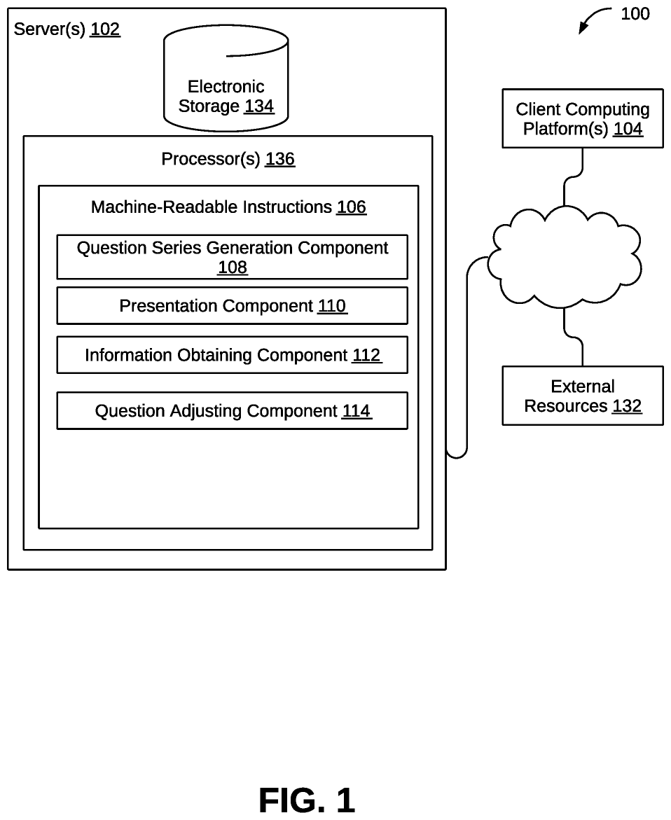

FIG. 1 illustrates a system 100 configured to provide a question series, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction components. The instruction components may include computer program components. The instruction components may include one or more of question series generation component 108, presentation component 110, information obtaining component 112, question adjusting component 114, and/or other instruction components.

Question series generation component 108 may be configured to receive questions for consumers, parameters, criteria to the parameters, and events corresponding to particular ones of the questions, and/or other information from client computing platform 104 associated with a user. The user may be associated with a business that may utilize system 100 to obtain information regarding their consumers, customers, clients, and/or players to facilitate enhancements to their online platform for their business and/or the business itself. For example, the business may be an online retailer, an online platform for a physically established retailer, an online game, a content providing platform, and/or other businesses that provides content, products, and/or services. The enhancements may include, for example, offering new products and/or services, designing new products, removing products, removing content, adding content, modifying content, and/or other changes that enhance the business.

The questions for the consumers may be questions intended for presentation to the consumers while virtually interacting with the business via client computing platforms 104. Some of the questions may correspond to individual ones of the parameters. The questions that correspond to the individual parameters may prompt values, from the consumers, to the parameters. The parameters may specify measurable, recordable, obtained, and/or determined information. The values to the parameters may be numerical or non-numerical and may facilitate obtaining insight on the consumers. Some of the parameters may characterize the consumers. By way of non-limiting example, the parameters may include age, gender, residence, device information, customer status, and/or other parameters. The residence may be where the consumer lives or resides. The device information may be related to client computing platform 104 such as device type (e.g., smartphone, laptop, desktop), operating system, processor type, memory, storage capacity, and/or other information.

In some implementations, rewordings or variations of a question may be specified by the user and obtained by question series generation component 108. In some implementations, the questions may include value choices (e.g., multiple choice question). Individual ones of the value choices may correspond to other ones of the questions. In some implementations, user interface elements for the individual questions may be specified by the user and obtained (by question series generation component 108) so that particular user interface elements are utilized by the consumers to provide response to the questions. An individual user interface element may be configured to be selected by the users to facilitate providing the responses to the questions. By way of non-limiting illustration, the user interface elements may include one or more of text input fields, drop down menus, check boxes, display windows, virtual buttons, and/or other user interface elements.

In some implementations, some of the parameter or all of the parameters may have criteria. A criterion to a given parameter may be a required value for the parameter. To satisfy the criterion to the given parameter, a value received from a consumer (or client computing platform 104 thereof) may match the required value or may be comparable to the required value. For example, the parameter may be undergraduate degree and the criterion may be a science degree. The value from the consumer may be geology, a science, therefore the criterion to the parameter is satisfied. Upon the criteria to the parameters being satisfied, one or more of the questions may be presented to the consumers, as described herein. In some implementations, the individual parameters may have criteria (i.e., more than one criterion). That is, the value from the consumer must satisfy more than one criterion for the parameter. For example, a first criterion for the undergraduate degree parameter may be a science and a second criterion may be medical-related (i.e., the criteria). Thus, geology as the value from the consumer may not satisfy the criteria, while biology may satisfy the criteria. By way of non-limiting illustration, the criterion to the customer status may include one of a new customer, a returning customer, and/or other customer status.

The events may correspond to particular ones of the questions. Upon occurrence of one or more of the events, one or more of the questions may be presented to the consumers. In some implementations, the events may cause presentation of the one or more questions. By way of non-limiting example, the events may include lapse of an amount of time since presentation of individual sets of questions (e.g., 24 hours), a particular time, transactions by the consumers, consumer interactions by the consumers, natural events, and/or other events. Upon occurrence of the particular time, such as 12:00 PM or a time on a particular date, the one or more questions may be presented. The particular time may be reoccurring (e.g., every 12:00 PM), singular, or temporarily reoccurring (e.g., every 12:00 PM for next 3 days). The transactions may include purchases, sales, rentals, trades, and/or other transactions by the consumers for merchandise. Merchandise may refer to one or more of a product (e.g., clothing), a service (e.g., vehicle installations), a virtual item, and/or other merchandise the consumer elects to transact with. In some implementations, the transactions may include establishing an account with the online platform for the business. The consumer interactions may include viewing content for a particular amount of time, listening to the content for the particular amount of time, viewing the merchandise for the particular amount of time, withdrawing the viewing of the content, withdrawing the listening of the content, withdrawing the viewing of the merchandise, log-ins (e.g., to the account on an online platform for the business), log-outs, time between the log-ins and the log-outs (i.e., amount of time of a session), and/or other consumer interactions. By way of non-limiting example, the content may include videos, audio, images, literary articles, and/or content type of the videos, the audio, the images, and/or other content.

The natural events may include a particular outdoor temperature of a location of the consumer, weather (e.g., sunny, cloudy, rainy, snowing, windy, etc.), and/or other natural events. In some implementations, information obtaining component 112 may be configured to obtain geolocation information indicating the location of the consumer or their client computing platform 104. Geolocation information may include determination of a real-world position or geographic location of the consumer. Client computing device 104 may be used to determine the (geographical) location of the consumer based on one or more of signal strength, GPS, cell tower triangulation, Wi-Fi location, receipt of the location from client computing platform 104 based on consumer input, and/or other input.

The criteria, the parameters, the questions (and variations thereof), the events, and/or other information may be specified by the user via client computing platform 104. The questions for the consumers, the parameters, the criteria, the events, and/or other information may be stored to electronic storage 134 by question series generation component 108. Occurrence of the events, satisfaction of the criteria to the parameters that include the criteria, and/or particular values to the individual parameters may affect presentation of particular ones of the questions.

Question series generation component 108 may be configured to generate a question series for presentation to individual ones of the consumers. The question series may comprise of a plurality of questions where one or more of the plurality of questions may be presented to the consumers at different points in time. An individual question series may correspond with a single consumer. The different points in time when the one or more questions may be presented to the consumer may be based on occurrence of the events, the values to the parameters, specifications by the user, and/or other information. For example, the user associated with the business may specify (via their client computing platform 104) to present one question from the question series for a give consumer every time they log in to their online platform associated with the business and one question every time the consumer performs one of the transactions.

The question series may be generated based on the parameters, the questions, and/or other information. The questions of/comprising the question series may adjust responsive to the occurrence of the events in relation to the individual consumers presented with the questions, responsive to the satisfaction of the criteria, based on values to the parameters, and/or other information. That is, in some implementations, the questions included in the question series may be adjusted. In some implementations, ensuing or upcoming questions in the question series for presented may be adjusted. Adjusting the questions may include one or more of the questions being removed, added, reworded, postponed presentation of, advanced presentation of, and/or other adjustments. By way of non-limiting illustration, a first question series may be generated for a first consumer. In some implementations, the same question series may be initially generated for all the consumers and subsequently individual question series per consumer may adjust based on the occurrence of the events in relation to the individual consumer presented with the questions, responsive to the satisfaction of the criteria by the individual consumer, based on values to the parameters from the individual consumer, and/or other information.

Presentation component 110 may be configured to effectuate presentation of a set of the questions of the question series via individual client computing platforms 104 associated with the consumers. Presentation component 110 may be configured to request the set of questions or subsequent question(s) in the question series. The request may be sent to and received by question series generation component 108 and/or question adjusting component 114 to determine the set of questions and/or subsequent sets of questions as defined by the question series. In some implementations, the set of questions may be presented with its corresponding user interface elements specified by the user. By way of non-limiting illustration, a first set of questions of the first question series may be presented to the first consumer via a first client computing platform 104 associated with the first consumer. In some implementations, the set of the questions of the question series for all the consumers may be the same. For example, the first set of questions presented to the first consumer via first client computing platform 104 may be the same as presented to a second consumer. The same first set of questions may facilitate determining adjustments to the question series for the individual consumers.

Information obtaining component 112 may be configured to obtain responses to the set of the questions from the individual client computing platforms 104 associated with the consumers. As the one or more questions included in the question series are presented to the consumers at different points in time, responses to such questions are obtained at those different points in time. The responses may include the values to the parameters. The responses may include an input response entered in a text field, a selection to one of the value choices presented as virtual buttons, check boxes, in a dropdown menu; a selection to multiple of the value choices presented as virtual buttons or checkboxes; a value based on a sliding scale, and/or other values via other user interface elements entered/selected by the consumers via client computing platforms 104. In some implementations, information obtaining component 112 may be configured to store the responses to electronic storage 134 in associated with the individual consumer. In some implementations, upon obtainment of responses to the set of questions or a question included in the set of questions and/or indications of occurrences of the events, information obtaining component 112 may request a subsequent question or set of questions from the question series to be presented immediately or next at a later time. In some implementations, upon obtainment of an empty response or upon a lack of responses to the set of questions presented, such questions may remain in the question series for inclusion in a subsequent set of questions presented to the consumer at a different point in time.

Information obtaining component 112 may be configured to obtain, in an ongoing manner, indications of occurrence of the events related to the individual consumers. The term “ongoing manner” as used herein may refer to continuing to perform an action (e.g., obtain) periodically (e.g., every 30 seconds, every minute, every hour, etc.), or upon occurrence of the events until receipt of an indication to terminate. The indication to terminate may include powering off client computing platform 104, charging one or more of a battery of client computing platform 104, resetting client computing platform 104, receipt of a termination indication from the consumers or the user via respective client computing platforms 104, and/or other indications of termination. The indications may include event information that characterizes the occurrence of the events and/or other information. The event information may include a time of the event, a date and the time of the event, identifying information of the consumer in relation to the event, and/or other event information. Identifying information may include a first name, a last name, a username, an account number, an email address, a phone number, and/or other information that may identify a consumer from other consumers. In some implementations, information obtaining component 112 may be configured to store the event information to electronic storage 134 in associated with the individual consumer.

In some implementations, where the events that occurred are the transactions, information obtaining component 112 may be configured to obtain transaction information related to the transactions responsive to the transactions. By way of non-limiting example, the transaction information may include the merchandise purchased, time of a transaction (e.g., of the merchandise purchased), an order number, prices of the merchandise, total price, discounts applied, a mailing address, a billing address, the email address, a gifted indication (i.e., the merchandise was a gift), payment type, and/or other transaction information. In some implementations, the account established with the online platform of the business (i.e., a transaction) may include a particular plan name that defines a service, a product, a package, and/or other information that the provider provides to the consumer. In some implementations, the establishment of the account may be free or require a cost or reoccurring fee.

Question adjusting component 114 may be configured to adjust the questions or the ensuing questions for presentation of the question series based on the occurrence of the events, the individual event information for the events, the responses, the transaction information, and/or other information. In some implementations, the question series or ensuing questions thereof may be adjusted in an ongoing manner as the events occur the individual event information for the events are obtained, the responses are obtained, the transaction information is obtained, and/or other information are obtained. Adjusting the questions may include removing, adding, rewording, postponing presentation of, advancing presentation of, and/or other adjustments to one or more of the questions. In some implementations, adjusting the ensuing questions may include adjusting how many of the ensuing questions will be presented. For example, one question may be presented after a next transaction and three questions may be presented during the next time the consumer interacts with the content (i.e., the consumer interaction).

In some implementations, question adjusting component 114 may be configured to receive user-specified adjustments to the question series. The user-specified adjustments may include the adjustments described herein and/or adjustments to the questions for the consumers, the parameters, the criteria, the events, and/or other information previous specified by the user and obtained by question series generation component 108. The adjustments to the previously specified and obtained information may include adding new questions, removing one or more questions, modifying one or more questions, adding criteria to some of the parameters, removing criteria to the parameters, modifying the criteria to the parameters, adding events, removing one or more of the events, modifying one or more of the events, adding questions in association with particular values to the parameters, removing questions in association with particular values to the parameters, modifying questions in association with particular values to the parameters, adding value choices for the questions, removing value choices for the questions, modifying the value choices for the questions, and/or other user-specified adjustments. Question adjusting component 114 may be configured to adjust the ensuing questions for presentation of the question series and/or the question series based on the user-specified adjustments and/or other information.

In some implementations, the event information and the responses may include previous ones of the events and previous ones of the responses. In some implementations, the ensuing questions and/or the question series may be adjusted in an ongoing manner based on a plurality of the event information stored to the electronic storage 134 in associated with the individual consumer, the responses stored to the electronic storage 134 in association with the individual consumer, and/or other information. That is, based on all previous occurrences of the events, and the event information thereof, and the responses previously obtained by information obtaining component 112, the ensuing questions and/or the question series may be adjusted in an ongoing manner.

In some implementations, upon the parameters including the criteria, question adjusting component 114 may be configured to determine the satisfaction of the criteria for the parameters based on the responses (i.e., the values to the parameters) and the criteria. In some implementations, determining the satisfaction may include comparing the criteria to the values for the parameters obtained. In some implementations, a criterion may be a category or a general type (e.g., the science major criterion) as opposed to a single value. Thus, determining the satisfaction may include determining whether the value is included in that category (e.g., geology included as science majors). Adjusting the question series may be based on the responses satisfying or not satisfying the criterion for the parameters.

In some implementations, the particular values included in the responses may correspond with other ones of the questions. In some implementations, the value choices presented may correspond with the other questions. In some implementations, the values entered by the consumer may correspond with the other questions. As such, the ensuing questions may be adjusted to include the other questions based on the particular values. By way of non-limiting illustration, a given response may include a primary value. Based on the primary value, the ensuing questions may be adjusted to include a question related to the primary value. Upon the given response including a secondary value, the ensuing questions may be adjusted to include a different question related to the secondary value and not the primary value.

In some implementations, question adjusting component 114 may be configured to store the question series and the adjustments to the individual question series to electronic storage 134 in association with the individual consumer. In some implementations, the question series may be stored to electronic storage 134 subsequent to generation or to effectuation of the presentation of the set of question from the question series. In some implementations, the question series may be stored to or updated in electronic storage 134 subsequent to the adjustments.

Presentation component 110 may be configured to effectuate presentation of a subsequent set of the questions from the question series via individual client computing platforms 104 of the consumers based on the adjustment to the ensuing questions. The subsequent set of the questions may be different than the (initial or previous) set of the questions. The subsequent set of the questions may include the adjusted ensuing questions. In some implementations, the effectuation of presentation of the subsequent set of questions may be responsive to occurrence of one or more of the events or a particular one of the events, and/or the request for the subsequent question or the subsequent set of the questions from the question series, of which may be adjusted based on the occurrence of the events, the event information, the responses, and/or other information. That is, the occurrence of the events may adjust the ensuing questions and/or may effectuate presentation of the subsequent set of questions that include the ensuing questions.

In some implementations, presentation component 110 may be configured to determine optimal times and idle times for presentation of one or more of the questions from the question series. The optimal times and the idle times may be determined based on the occurrences of the events, the event information for the individual events, the responses, and/or other information related to the individual consumers or all the consumers. In some implementations, the optimal times and the idle times may be determined based on novel and/or known machine learning techniques. The optimal times may be times when questions are to be presented by presentation component 110. The idle times may be times when questions are not to be presented by presentation component 110. For example, a first optimal time to present two questions from the question series may be upon log in. As another example, a first idle time to not present questions from the question series may be subsequent to an incomplete transaction (e.g., merchandise becomes out of stock). In some implementations, the optimal times and the idle times may be defined by user input received via client computing platform 104 associated with the user from the business. In some implementations, the optimal times and the idle times determined may be general for the question series for all consumers. In some implementations, the optimal times and the idle times determined may be for the individual question series for the individual consumers.

By way of non-limiting illustration, the first set of questions may include a first question. The first question may correspond to a first parameter. The first parameter may include a first criterion. A first response of the first consumer may be obtained (i.e., by information obtaining component 112). The first response may include a first value to the first parameter. Upon the first value satisfying the first criterion, the ensuing question for the first question series may be adjusted so that a second (subsequent) set of questions from the first question series includes a second question. Upon the first value not satisfying the first criterion, the ensuing question for the first question series may be adjusted so that the second (subsequent) set of questions from the first question series does not include the second question.

By way of non-limiting illustration, upon the first consumer viewing videos for 45 minutes (i.e., the consumer interaction as the event), the ensuing question of the first question series may be adjusted to include a third question related to video streaming services. Upon the first consumer exiting viewing the videos (i.e., another event), a (subsequent) third set of questions may be presented to the first consumer via first client computing platform 104. The third set of questions may include the third question and other questions.

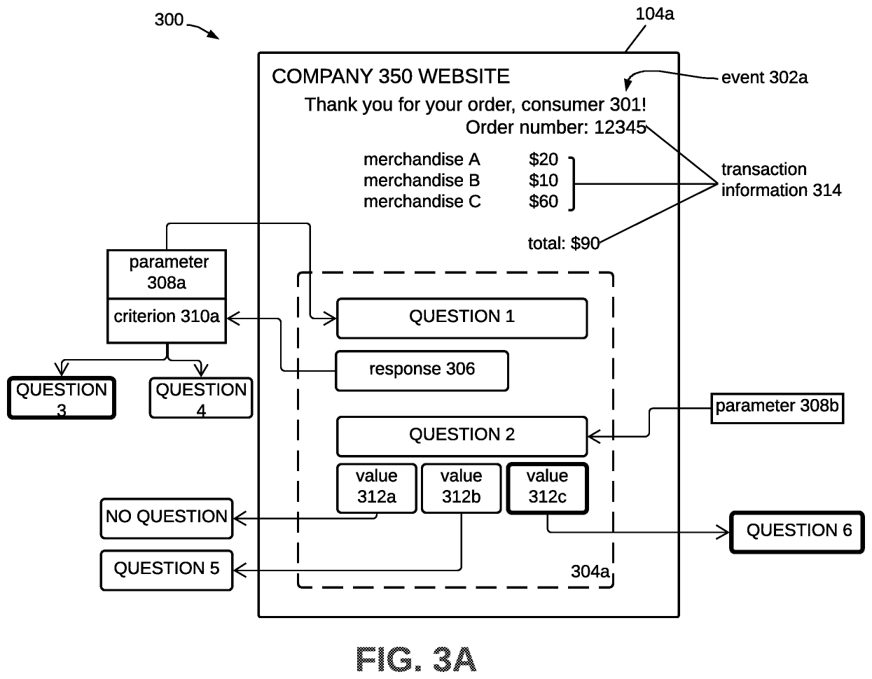

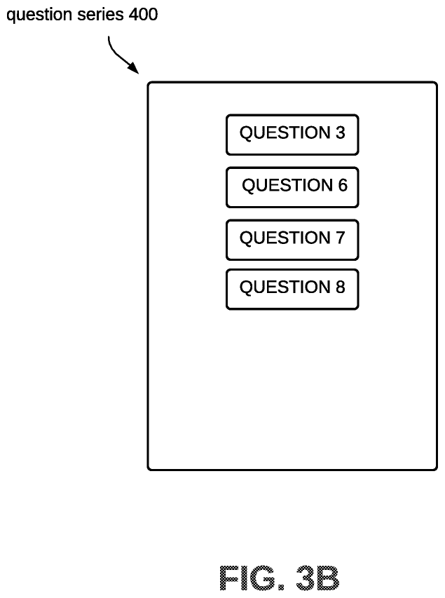

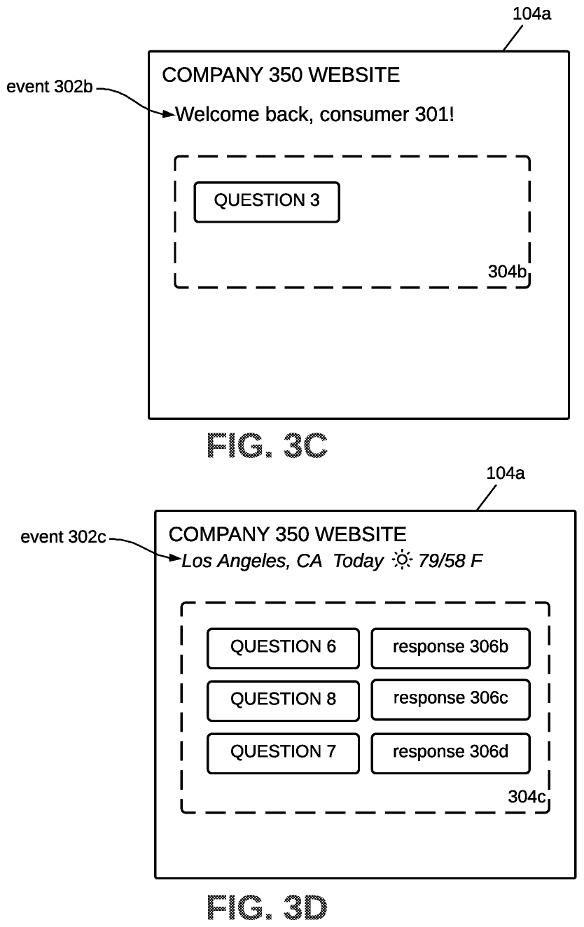

FIG. 3A-C illustrate an example implementation of the question series, in accordance with one or more implementations. A consumer 301 may complete a transaction, i.e., event 302a, with a company 350 via client computing platform 104a. Subsequent to event 302a (i.e., the transaction), a question set 304a, including a question 1 and a question 2, may be presented via client computing platform 104a. Question 1 may correspond to a parameter 308a. Parameter 308a may include a criterion 310a. Upon a response 306 to question 1 satisfying criterion 310a, a question series 400 in FIG. 3B for consumer 301 may be adjusted so that ensuing questions include a question 3. Conversely, upon response 306 not satisfying criterion 310a, question series 400 may be adjustment so that the ensuing questions include a question 4. As illustrated in FIGS. 3A and 3B, question series 400 may include question 3 based on response 306.

Question 2 may correspond with a parameter 308b and value choices 312a-c. Question 2 may be presented with a choice between value choices 312a-c for parameter 308b. Based on consumer 301 choosing one of value 312a-c for parameter 308b, question series 400 may be adjusted so that the ensuing questions include no question, a question 5, or a question 6, respectively. As illustrated in FIGS. 3A and 3B, question series 400 may include question 6 based on consumer 301 choosing value 312c.

Based on event 302a, transaction information 314 may be stored to electronic storage 134 of FIG. 1. Transaction information 314 may include an order number 12345, merchandise A, B, C purchased (and prices thereof), and total cost $90. Based on transaction information 314, a question 7 may be included in question series 400 as illustrated in FIG. 3B.

Referring to FIG. 3C, responsive to an event 302b (i.e., a log-in) by consumer 301 occurring subsequent to event 302a, a question set 304b including question 3, may be presented via client computing platform 104a based on question series 400. Question 3 may be included in question set 304b responsive to a request to question series 400 for one or more subsequent questions to present responsive to event 302b.

Referring to FIG. 3D, responsive to an event 302c (i.e., outdoor weather/a natural event) occurring subsequent to event 302b, question series 400 may be adjusted to include question 8. Further responsive to event 302c, a question set 304c may be presented via client computing platform 104a. Question set 304c may include question 8, question 6, and question 7 based on question series 400. Questions 8, 6, and 7 may be included in question set 304c responsive to a request to question series 400 for subsequent questions to present responsive to event 302c.

Referring back to FIG. 1, in some implementations, server(s) 102, client computing platform(s) 104, and/or external resources 132 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 132 may be operatively linked via some other communication media.

A given client computing platform 104 may include one or more processors configured to execute computer program components. The computer program components may be configured to enable an expert or user associated with the given client computing platform 104 to interface with system 100 and/or external resources 132, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 132 may include sources of information outside of system 100, external entities participating with system 100, and/or other resources. In some implementations, some or all of the functionality attributed herein to external resources 132 may be provided by resources included in system 100.

Server(s) 102 may include electronic storage 134, one or more processors 136, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 134 may comprise non-transitory storage media that electronically stores information. The electronic storage media of electronic storage 134 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 134 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 134 may include one or more virtual storage resources (e.g., cloud storage, a virtual private network, and/or other virtual storage resources). Electronic storage 134 may store software algorithms, information determined by processor(s) 136, information received from server(s) 102, information received from client computing platform(s) 104, and/or other information that enables server(s) 102 to function as described herein.

Processor(s) 136 may be configured to provide information processing capabilities in server(s) 102. As such, processor(s) 136 may include one or more of a digital processor, an analog processor, a digital circuit designed to process information, an analog circuit designed to process information, a state machine, and/or other mechanisms for electronically processing information. Although processor(s) 136 is shown in FIG. 1 as a single entity, this is for illustrative purposes only. In some implementations, processor(s) 136 may include a plurality of processing units. These processing units may be physically located within the same device, or processor(s) 136 may represent processing functionality of a plurality of devices operating in coordination. Processor(s) 136 may be configured to execute components 108, 110, 112, and/or 114, and/or other components. Processor(s) 136 may be configured to execute components 108, 110, 112, and/or 114, and/or other components by software; hardware; firmware; some combination of software, hardware, and/or firmware; and/or other mechanisms for configuring processing capabilities on processor(s) 136. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, and/or 114 are illustrated in FIG. 1 as being implemented within a single processing unit, in implementations in which processor(s) 136 includes multiple processing units, one or more of components 108, 110, 112, and/or 114 may be implemented remotely from the other components. The description of the functionality provided by the different components 108, 110, 112, and/or 114 described below is for illustrative purposes, and is not intended to be limiting, as any of components 108, 110, 112, and/or 114 may provide more or less functionality than is described. For example, one or more of components 108, 110, 112, and/or 114 may be eliminated, and some or all of its functionality may be provided by other ones of components 108, 110, 112, and/or 114. As another example, processor(s) 136 may be configured to execute one or more additional components that may perform some or all of the functionality attributed below to one of components 108, 110, 112, and/or 114.

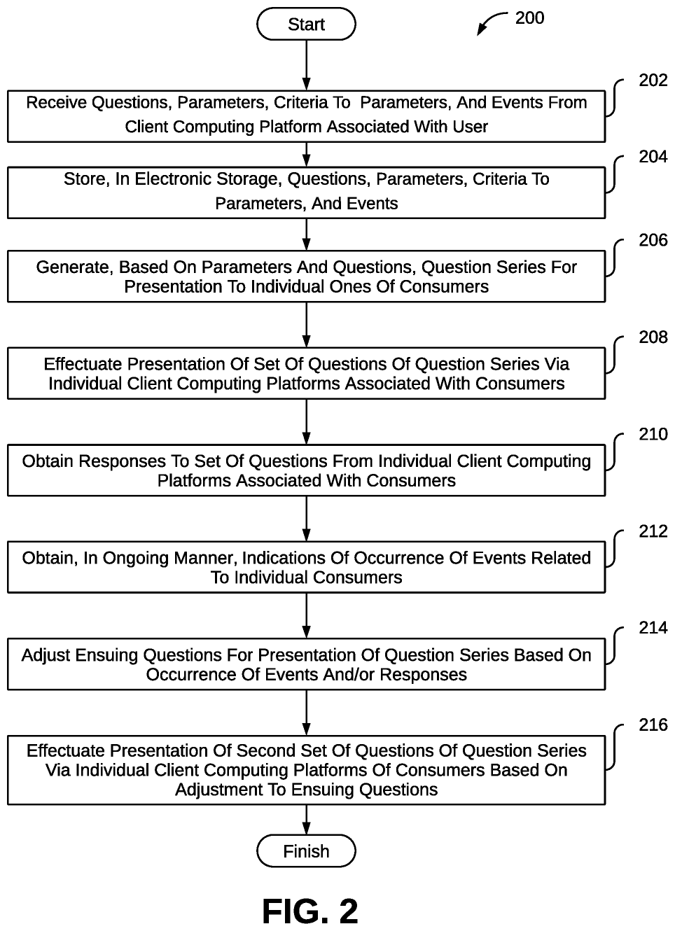

FIG. 2 illustrates a method 200 to provide a question series, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include receiving questions, parameters, criteria to the parameters, and events from a client computing platform associated with the user. Occurrence of the events, satisfaction of the criteria, and particular values to the individual parameters may affect presentation of particular ones of the questions. Operation 202 may be performed by one or more hardware processors configured by machine-readable instructions including a component that is the same as or similar to question series generation component 108, in accordance with one or more implementations.

An operation 204 may include storing, in electronic storage, the questions, the parameters, the criteria to some of the parameters, and the events corresponding to particular ones of the questions. The criteria, the parameters, the questions, the events may be specified by the user. Operation 204 may be performed by one or more hardware processors configured by machine-readable instructions including a component that is the same as or similar to question series generation component 108, in accordance with one or more implementations.

An operation 206 may include generating, based on the parameters and the questions, a question series for presentation to individual ones of the consumers. The questions of the question series may adjust responsive to the occurrence of the events in relation to the individual consumers presented with the questions, responsive to the satisfaction of the criterion, and based on values to the parameters. Operation 206 may be performed by one or more hardware processors configured by machine-readable instructions including a component that is the same as or similar to question series generation component 108, in accordance with one or more implementations.

An operation 208 may include effectuating presentation of a set of the questions of the question series via individual client computing platforms associated with the consumers. Operation 208 may be performed by one or more hardware processors configured by machine-readable instructions including a component that is the same as or similar to presentation component 110, in accordance with one or more implementations.

An operation 210 may include obtaining responses to the set of the questions from the individual client computing platforms associated with the consumers. The responses may include the values to the parameters. Operation 210 may be performed by one or more hardware processors configured by machine-readable instructions including a component that is the same as or similar to information obtaining component 112, in accordance with one or more implementations.

An operation 212 may include obtaining, in an ongoing manner, indications of the occurrence of the events related to the individual consumers. Operation 212 may be performed by one or more hardware processors configured by machine-readable instructions including a component that is the same as or similar to information obtaining component 112, in accordance with one or more implementations.

An operation 214 may include adjusting the ensuing questions for presentation of the question series based on the occurrence of the events and/or the responses. Operation 214 may be performed by one or more hardware processors configured by machine-readable instructions including a component that is the same as or similar to question adjusting component 114, in accordance with one or more implementations.

An operation 216 may include effectuating presentation of a subsequent set of the questions of the question series via individual client computing platforms of the consumers based on the adjustment to the ensuing questions. Operation 216 may be performed by one or more hardware processors configured by machine-readable instructions including a component that is the same as or similar to presentation component 110, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured to identify and present a question series, the system comprising:
electronic storage configured to store questions for consumers, parameters, criteria to some of the parameters, and events corresponding to particular ones of the questions, wherein some of the questions correspond to individual ones of the parameters, wherein the criteria, the parameters, the questions, and the events are specified by a user; and
one or more processors configured by machine-readable instructions to:
receive the parameters, the criteria to the parameters, the questions, and the events from a client computing platform associated with the user, wherein occurrence of the events, satisfaction of the criteria, and particular values to the individual parameters affect presentation of particular ones of the questions;
generate, based on the parameters and the questions, a question series for presentation to individual ones of the consumers, wherein the questions of the question series adjust (i) responsive to the occurrence of the events in relation to the individual consumers presented with the questions, (ii) responsive to the satisfaction of the criteria, and (iii) based on values to the parameters;
effectuate presentation of a set of the questions of the question series via individual client computing platforms associated with the consumers;
obtain responses to the set of the questions from the individual client computing platforms associated with the consumers, wherein the responses include the values to the parameters;
obtain, in an ongoing manner, indications of the occurrence of the events related to the individual consumers;
adjust the ensuing questions for presentation of the question series based on the occurrence of the events and the responses; and
effectuate presentation of a subsequent set of the questions from the question series via individual client computing platforms of the consumers based on the adjustment to the ensuing questions.

2. The system of claim 1, wherein the parameters include age, gender, residence, device information, and/or customer status, wherein criterion to the customer status includes one of a new customer and a returning customer.

3. The system of claim 2, wherein the one or more processors are further configured by the machine-readable instructions to:
determine the satisfaction of the criteria for the parameters upon the parameters including the criteria and based on the responses and the criteria, wherein adjusting the ensuing question of the question series is based on the responses satisfying or not satisfying the criteria for the parameters.

4. The system of claim 1, wherein the particular values included in the responses correspond with other ones of the questions, such that the ensuing questions are adjusted to include the other questions based on the particular values.

5. The system of claim 1, wherein the events include lapse of an amount of time since presentation of the set of questions, a particular time, transactions by the consumers, consumer interactions by the consumers, and/or natural events, wherein the consumer interactions include viewing content for a particular amount of time on an online platform via the client computing platform, listening to the content for the particular amount of time the online platform via the client computing platform, viewing merchandise for the particular amount of time the online platform via the client computing platform, log-ins to the online platform, and time between the log-ins and log-outs from the online platform, wherein the one or more processors are further configured by the machine-readable instructions to:
obtain transaction information related to the transactions responsive to the transactions, wherein adjusting the ensuing questions of the question series is based on the transaction information.

6. The system of claim 5, wherein the transaction information includes the merchandise purchased, time of a transaction, an order number, prices of the merchandise, and/or discounts applied.

7. The system of claim 5, wherein the content includes videos, audio, images, literary articles, and/or content type of the videos, the audio, and the images.

8. The system of claim 1, wherein the one or more processors are further configured by the machine-readable instructions to:
receive user-specified adjustments to the question series; and
adjust the ensuing questions for presentation of the question series based on the user-specified adjustments.

9. The system of claim 1, wherein the indication of the occurrence of the events includes event information characterizing the occurrence of the events, wherein the one or more processors are further configured by the machine-readable instructions to:
store the event information to the electronic storage in associated with the individual consumer;
store the responses to the electronic storage in associated with the individual consumer; and
store the question series and the adjustments to the individual question series to the electronic storage in associated with the individual consumer.

10. The system of claim 9, wherein the ensuing questions are adjusted in an ongoing manner based on the event information and the responses stored to the electronic storage in associated with the individual consumer.

11. A method to identify and present a question series, the method comprising:
receiving questions for consumers, parameters, criteria to the parameters, and events from a client computing platform associated with a user, wherein occurrence of the events, satisfaction of the criteria, and particular values to the individual parameters affect presentation of particular ones of the questions, wherein some of the questions correspond to individual ones of the parameters;
storing, in electronic storage, the questions, the parameters, the criteria to some of the parameters, and the events corresponding to particular ones of the questions, wherein the criteria, the parameters, the questions, and the events are specified by the user;
generating, based on the parameters and the questions, a question series for presentation to individual ones of the consumers, wherein the questions of the question series adjust (i) responsive to the occurrence of the events in relation to the individual consumers presented with the questions, (ii) responsive to the satisfaction of the criteria, and (iii) based on values to the parameters;
effectuate presentation of a set of the questions of the question series via individual client computing platforms associated with the consumers;
obtaining responses to the set of the questions from the individual client computing platforms associated with the consumers, wherein the responses include the values to the parameters;
obtaining, in an ongoing manner, indications of the occurrence of the events related to the individual consumers;
adjusting the ensuing questions for presentation of the question series based on the occurrence of the events and the responses; and
effectuating presentation of a subsequent set of the questions from the question series via individual client computing platforms of the consumers based on the adjustment to the ensuing questions.

12. The method of claim 11, wherein the parameters include age, gender, residence, device information, and/or customer status, wherein criterion to the customer status includes one of a new customer and a returning customer.

13. The method of claim 12, further comprising:
determining the satisfaction of the criteria for the parameters upon the parameters including the criteria and based on the responses and the criteria, wherein adjusting ensuing questions of the question series is based on the responses satisfying or not satisfying the criteria for the parameters.

14. The method of claim 11, wherein the particular values included in the responses correspond with other ones of the questions, such that the ensuing questions are adjusted to include the other questions based on the particular values.

15. The method of claim 11, wherein the events include lapse of an amount of time since presentation of the set of questions, a particular time, transactions by the consumer, consumer interactions, and/or natural events, wherein the consumer interactions include viewing content for a particular amount of time on an online platform via the client computing platform, listening to the content for the particular amount of time the online platform via the client computing platform, viewing merchandise for the particular amount of time the online platform via the client computing platform, log-ins to the online platform, and time between the log-ins and log-outs from the online platform, further comprising:
obtaining transaction information related to the transactions responsive to the transactions, wherein adjusting the ensuing questions of the question series is based on the transaction information.

16. The method of claim 15, wherein the transaction information includes the merchandise purchased, time of a transaction, an order number, prices of the merchandise, and/or discounts applied.

17. The method of claim 15, wherein the content includes videos, audio, images, literary articles, and/or content type of the videos, the audio, and the images.

18. The method of claim 11, further comprising:
receiving user-specified adjustments to the question series; and
adjusting the ensuing questions for presentation of the question series based on the user-specified adjustments.

19. The method of claim 11, wherein the indication of the occurrence of the events includes event information characterizing the occurrence of the events, further comprising:
storing the event information to the electronic storage in associated with the individual consumer;
storing the responses to the electronic storage in associated with the individual consumer; and
storing the question series and the adjustments to the individual question series to the electronic storage in associated with the individual consumer.

20. The method of claim 19, wherein the ensuing questions are adjusted in an ongoing manner based on the event information and the responses stored to the electronic storage in associated with the individual consumer.
